(19) United States
(12) Patent Application Publication
(10) Pub. No.: US 2001/0039464 A1
(43) Pub. Date: Nov. 8, 2001

(54) Device and method for controlling the force exerted by the clamping jaws of lift trucks

(76) Inventor: Klaus Dieter Hackauf, Braunschweig (DE)

Correspondence Address: Jodi-Ann McLane, Salter & Michaelson, 321 South Main Street, Providence, RI, 02903-7128, US

(21) Appl. No.: 09/809,693

(22) Filed: Mar. 15, 2001

(30) Foreign Application Priority Data
Mar. 15, 2000 (DE) 100 12 391.0

(51) Int. Cl. G06F 7/00

(52) U.S. Cl. 700/213

(57) ABSTRACT

Lift trucks are intended for the transportation of loads of differing weight, inter alia, between two clamping jaws. A device for controlling the force exerted by the clamping jaws in such lift trucks (10) is characterized in that the load (20) is equipped with a data carrier (21) which holds information in regard to the weight of the load (20) in the form of a code. Moreover, the lift truck (10) includes a reading device (30) for reading this code, a computing unit (31) and a storage unit (32). The computing unit (31) extracts the information in regard to the weight of the load (20) from the read-out code. The storage unit (32) contains a data matrix which contains a pressure that is required for the clamping force of the clamping jaws in dependence on the potential loads. There is provided a control device (33) which, with the aid of this data matrix, effects a continuous control of the clamping force of the clamping jaws (15) of the lift truck (10).

A device for and a method of controlling the force exerted by the clamping jaws of lift trucks

The invention relates to a device for and a method of controlling the force exerted by the clamping jaws of lift trucks, with which loads of differing weight are to be transported between two clamping jaws. In particular, the device can be used in connection with an attachment on the lift trucks.

Amongst other things, paper reels too, are transported with the aid of lift trucks and the attachments mounted thereon. For example, this form of transportation is used in a paper manufacturing plant, and it may also be used during further processing thereof e.g. in newspaper publishing plants. Paper reels are extremely delicate. For the purposes of transportation, the reels are grasped by means of the two jaws of a clamping device arranged on the lift truck, lifted, and then transported to the desired location by means of the mobile lift truck, for example, from a store to a lorry. The shape of the jaws is matched to the diameters of conventional paper reels i.e. they are rounded in concave manner. However, if these jaws grip the reels too firmly, the sought for roundness of the paper reels will immediately be slightly altered. These paper reels are thereby inclined to be unbalanced when subsequently disposed in high precision devices and hence cause problems during further processing. Thus, one might consider here the e.g. round paper bales which are needed when producing newspapers, these should of course run as uniformly as possible on high-speed rotating plants irrespective of their previous transportation histories.

Naturally, the pressure of the jaws on the paper reels should not be too light or too low. This would lead to the danger, namely, that the paper reels could slip out of the jaws due to their weight and then fall onto the ground thereby becoming quite unusable as a result of the ensuing crushing.

It is inherent to the nature of the manufacturing process that the individual paper bales will have differing weights. Consequently, it would be desirable if the clamping force could be made to be dependent on the weight, and if this could be done as precisely as possible.

A corresponding device was proposed in EP 0 664 272 B1, wherein the weights that were actually effective on the clamping jaws were measured. The heavier the paper reel, the greater the force applied by these clamping jaws, whether stationary or during uniform travel. When travelling over bumps in the ground, this conception naturally led to greater forces suddenly being applied since the ensuing forces were effective upon the measuring device. Such behaviour is therefore, unsatisfactory. The same applies to the method that was proposed in EP 0 443 998 A1. Here too, any slippage occurring between the jaws and the paper reels being transported by these clamping jaws was measured or tapped off.

In comparison thereto, the object of the present invention is to propose an improved control device and a corresponding method by means of which these problems can be alleviated.

This object is achieved in the case of a method in that, in the course of the manufacturing process, a code incorporating information in regard to the weight is allocated to the load (paper reels for example), in that prior to or during the process of picking up the load (paper reel) by the lift truck, the code associated with this load is read out by means of a reading device, in that the weight of the load that is stored in this code is extracted therefrom and conveyed to a computing unit including a storage unit, in that a data matrix is provided in the storage unit, said data matrix containing a pressure that is required for the clamping force in dependence on the potential loads, and in that the clamping force of the clamping jaws of the lift truck is controlled by means of this data matrix.

This object is achieved in the case of a device, in that the load (paper reel) is equipped with a data carrier which holds information in regard to the weight of the load in the form of a code, in that the lift truck includes a reading device for reading this code, a computing unit and a storage unit which incorporates a data matrix that contains a pressure that is required for the clamping force of the clamping jaws in dependence on the potential loads, and in that there is provided a control device which controls the clamping force of the clamping jaws of the lift truck by means of this data matrix.

Even hitherto, paper reels regularly carried adhesive labels incorporating a barcode. The barcode serves for identification purposes, for store administration purposes and also, inter alia, for billing purposes. After all, a paper processing company has to be able to determine what paper reels are in store and which ones have to be transported to where, and which of them have been sold to which customer. The data includes, for example, the purchaser, the delivery number, the dimensions and also, inter alia, the total weight since this of course is essential to the paper processing or manufacturing company for invoicing purposes. Until now however, the data concerning the weight had no other significance.

In accordance with the invention, the data disposed on the paper reels to be transported can now be read by means of a reading device which is located on the fork lift vehicle or on the attachment. Such reading devices are frequently provided there in any case, since the driver of the lift truck can easily use them to identify the object that he is supposed to be transporting.

The reading devices are designed for use at great distances since the barcodes may be located some several metres away from the reading heads.

Now however, in accordance with the invention and apart from the information used for identification purposes in the lift truck and possibly too the information that is used therein for locating purposes, that particular package of information which contains the weight data is separated out from the total amount of data. This weight data is generally measured immediately after the manufacture of the paper length, shortly before the adhesive barcode label is applied. It will thus generally be substantially the same as the actual weight. Any deviations therefrom will merely consist of the moisture content which has a tendency to decrease, although this can be taken into account by suitable calculations.

It is precisely this separated package of information relating to the weight that can now be passed on to a data storage unit by the control unit. Then, in accordance with the invention, this data storage unit is provided with a data matrix which contains means for converting the weight i.e. the load, into a corresponding desired force for the clamping jaws.

The appropriate clamping force is then determined from this data and is used to control the hydraulic system.

The control process is advantageously effected in a continuous manner.

By virtue of the invention, it now becomes possible to transport not only paper bales, but also other equally delicate products incorporating barcodes, in a safer, more reliable and improved manner.

It is of particular advantage if a plausibility check is also effected. It may happen that two paper reels must or might need transporting simultaneously one after the other, and that provision should then be made for the two adhesive barcode labels to be read and appropriately added. In order to ensure this, a large deviation of the value of the barcode from the actual weight could be determined by the control device and the appropriate measures then taken.

In practice, the loading process might function somewhat as follows: firstly, the printed barcode upon the paper reel will be sighted by means of a barcode reading device. The barcode reading device could be adjustable e.g. by means of a joystick.

The recorded data is transferred to the computing unit after the reading process has finished. The data packet relating to the weight is then separated out by the computing unit, processed in the data storage unit by means of the data matrix and finally used to control a proportional valve connected thereto. This then produces the clamping force or clamping jaw force that is required for the load. The paper reel can then be clamped and transported using this force.

An embodiment of the invention will be explained in detail hereinafter with the help of the drawing. Therein

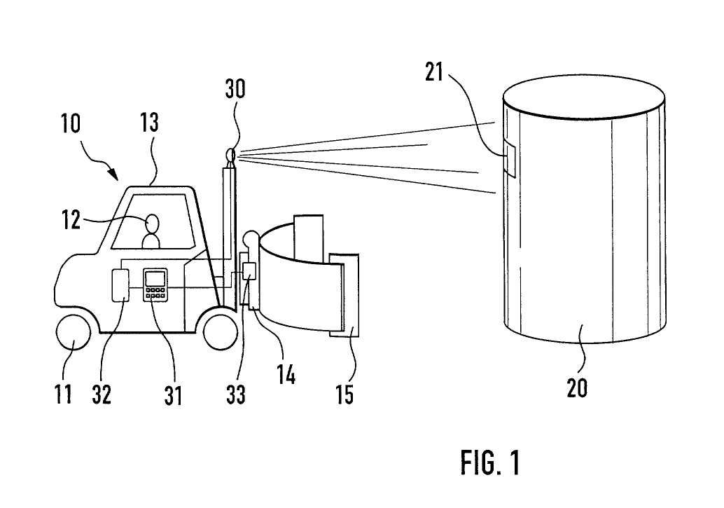

FIG. 1 shows a schematic illustration of the lift truck and of a load that is to be transported thereby; and

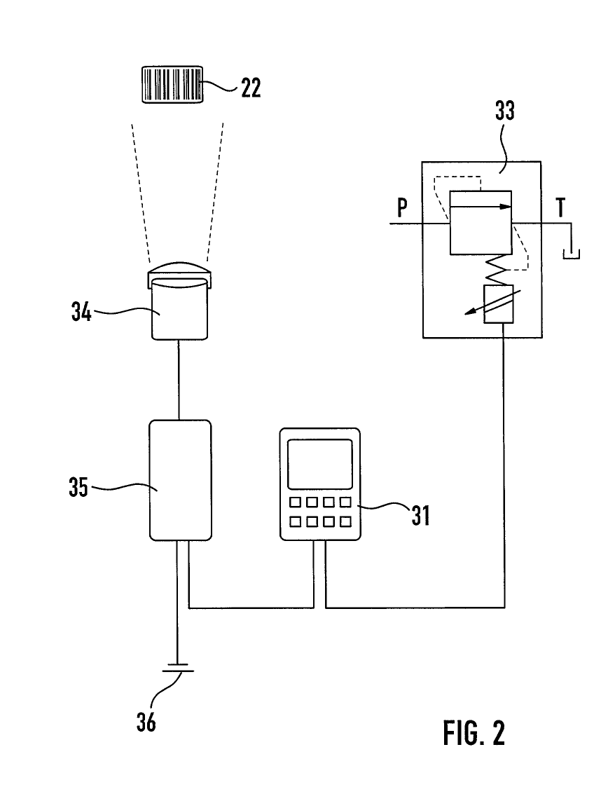

FIG. 2 a block diagram incorporating a part of the device in accordance with the invention.

In FIG. 1, there is illustrated in a purely schematic manner, a lift truck 10 of which two wheels 11 and an illustrative driver 12 under a roof 13 of the lift truck 10 can be perceived.

An attachment 14 incorporating clamping jaws 15 is disposed on the lift truck.

The lift truck 10 moves on the wheels 11 in order to transport the loads that are disposed between the clamping jaws 15. The attachment 14 provides for the to-and-fro movement of the clamping jaws 15 which enables a load located therebetween to be securely retained or released for unloading purposes.

In the embodiment illustrated, the lift truck 10 is provided for the purposes of transporting a load 20, here, a paper reel. This paper reel may have very considerable dimensions and is cylindrical. A data carrier 21 having a code thereon is provided on the load 20 i.e. the cylindrical paper reel, whereby here, the data carrier 21 is in the form of a stick-on label that is printed with a barcode.

A reading device 30 is disposed on the roof 13 of the lift truck 10. This reading device 30 may be equipped with a headlight which can be aligned on the data carrier 21 on the load 20 by the driver 12 of the lift truck 10, for example, by means of a joystick, in order to provide adequate illumination. The reading device 30 incorporates a reading unit which is especially equipped for such distances and which is used for recording the bar codes on the data carrier 21.

The reading device 30 passes the results that have been read thereby to a computing unit 31. The computing unit 31 is capable of extracting those data packets which relate to the stored weight of the load 20 from the total amount of information that has been supplied thereto. Namely, the barcode on the data carrier 21 contains a plurality of items of information which e.g. serve, inter alia, for identifying the load 20, the customer to which this paper reel should be delivered, the day on which it was manufactured, and, the weight thereof, which is the item of relevance to the invention.

The computing unit 31 discards those items of information that are of no interest thereto, or, it passes them on to other devices which are neither of interest nor are illustrated here. Furthermore, it accesses a storage unit 32 which could be an integral component of the computing unit 31. A data matrix is provided in this storage unit 32. This data matrix indicates a particular pressure that has to be applied by a hydraulic device in respect of potential loads, said hydraulic device providing the clamping force for the clamping jaws 15 of the attachment 14 on the lift truck 10. The information in regard to the actual weight of the load 20 that has been read out from the information on the data carrier 21 is now compared with this data matrix in the storage unit 32 and the currently relevant values are then passed on to a control device 33.

During the course of this process or even thereafter, the lift truck 10 moves towards the load 20 so that the clamping jaws 15 can grasp the paper reel i.e. the load 20. The control device 33 then indicates the pressure which will determine the clamping force to be exerted by the clamping jaws 15. The not illustrated elements of the attachment 14 ensure that the load 20 can be lifted up from the ground once it has been grasped correctly by the clamping jaws 15.

A block diagram in regard to the electrical functioning of the arrangement is illustrated in FIG. 2 but on a larger scale than is the case in FIG. 1.

One can again perceive the data carrier 21, a label which clearly shows an exemplary barcode 22 that has been applied thereto.

This barcode 22 on the data carrier 21 is then read by the reading device 30 which comprises a barcode scanner 34 for this purpose. The functioning of the barcode scanner 34 is controlled by a control device 35. A power supply 36 for the control device 35, the scanner 34 and various other components is likewise indicated.

A purely schematically indicated computing unit 31 receives the information from the scanner 34 via the control device 35 thereof. Here, the computing unit 31 incorporates a storage unit 32.

The control device 33 is connected to the output of the computing unit 31. Here, the control device comprises a proportional pressure limiting valve which forms the heart of this embodiment.

List of References

10 lift truck

11 wheels

12 driver

13 roof

14 attachment

15 clamping jaws

20 load e.g. paper reel

21 data carrier

22 barcode

30 reading device

31 computing unit

32 storage unit

33 control device

34 barcode scanner

35 control device for the scanner

36 power supply

1. In lift trucks (10), with which loads (20) of differing weight are to be transported whilst clamped between two clamping jaws (15), a method of controlling the force exerted by the clamping jaws,
characterised
in that, in the course of the manufacturing process, a code incorporating information in regard to the weight thereof is allocated to the loads (20),
in that prior to or during the process of picking up the load (20) by the lift truck (10), the code associated with this load (20) is read out by means of a reading device (30),
in that the weight of the load (20) stored in this code is extracted therefrom and conveyed to a computing unit (30) including a storage unit (32),
in that a data matrix is provided in the storage unit (32), said data matrix containing a pressure that is required for the clamping force in dependence on the potential loads, and
in that the clamping force of the clamping jaws (15) of the lift truck (10) is controlled by means of this data matrix.

2. A method in accordance with claim 1, characterised in that the weight, which is in the form of a code incorporating information, is a bar code.

3. A device for controlling the jaw clamping force of lift trucks (10), with which loads of differing weight (20) are to be transported whilst clamped between two clamping jaws (15),
characterised,
in that the load (20) is equipped with a data carrier (21) which holds information in regard to the weight of the load (20) in the form of a code,
in that the lift truck (10) includes a reading device (30) for reading this code, a computing unit (31) and a storage unit (32), whereby the computing unit (31) extracts the information in regard to the weight of the load (20) from the read-out code and the storage unit (32) contains a data matrix which contains a pressure that is required for the clamping force of the clamping jaws (15) in dependence on the potential loads, and
in that there is provided a control device (33) which controls the clamping force of the clamping jaws (15) of the lift truck (10) by means of this data matrix.

4. A method [sic] in accordance with claim 3, characterised in that the data carrier (21) comprises a bar code.
